(19) United States
(12) Patent Application Publication
(10) Pub. No.: US 2013/0001986 A1
(43) Pub. Date: Jan. 3, 2013

(54) Vehicle rear structure

(75) Inventor: Sho TAKENAKA, Hamamatsu (JP)

(73) Assignee: SUZUKI MOTOR CORPORATION, Hamamatsu (JP)

(21) Appl. No.: 13/533,752

(22) Filed: Jun. 26, 2012

(30) Foreign Application Priority Data
Jun. 30, 2011 (JP) 2011-145153

(51) Int. Cl. B62D 25/08

(52) U.S. Cl. 296/193.08

(57) ABSTRACT

A vehicle rear structure is provided that can efficiently transmit input loads, and ensure sufficient durability against any input load that may be repeatedly applied in normal usage during the life cycle of a vehicle. A representative configuration of a vehicle rear structure according to the present invention is a vehicle rear structure for supporting, at the rear of a vehicle, an opening and closing body that can be opened and closed, including: a back panel disposed in an area extending from a lower end of the opening and closing body to the bottom of the vehicle; and a striker bracket provided substantially at the center in the width direction of the vehicle on a vehicle front-side of the back panel and extending from the vicinity of an upper end of the back panel to the vicinity of a lower end thereof.

### CROSS-REFERENCE TO RELATED APPLICATIONS

This application is based upon and claims the benefit of priority from the prior Japanese Patent Application No. 2011-145153, filed on Jun. 30, 2011, the entire contents of which are incorporated herein by reference.

### BACKGROUND OF THE INVENTION

1. Field of the Invention

The present invention relates to a vehicle rear structure serving as a rear structure of an automobile.

2. Background of the Invention

A back door serving as an opening and closing body is provided at the rear of an automobile. Ordinarily, the back door is engaged by meshing between a striker connected to the vehicle body and a latch connected to the back door. Conventionally, a configuration has been mainly used in which a large aperture is formed in a tail-end member overlapping with the upper portion of a back panel and extending in the width direction of the vehicle, and the above-described striker is mounted to a striker bracket overlapping a location underneath the opening. In other words, a configuration has been mainly used in which the striker is mounted not via the tail-end member. This was intended to prevent water flowing to the striker along the latch connected to the back door from entering therefrom to the vehicle interior along the tail-end member.

However, in the case of mounting the striker not via the tail-end member as described above, there is a problem in that it is questionable whether sufficient durability can be ensured against any input load that may be repeatedly applied in normal usage during the life cycle of a vehicle. Any input load that may be repeatedly applied in normal usage refers to, for example, a load applied when closing the back door and a load applied to the vehicle when a jack-up is performed using the vicinity of a towing hook as the jack point.

In this respect, Japanese Patent Laid-open Publication No. Sho58-73450 discloses a technique in which the rear end of a reinforcing bracket mounted to the undersurface of the rear edge of a rear floor panel is provided extending upward, this extending portion is guided to the vehicle interior through the space between the rear floor panel and a rear end panel, and the upper end of the extending portion is coupled to a lock reinforcement. According to Japanese Patent Laid-open Publication No. Sho58-73450, mounting a tie down hook (corresponding to the towing hook of the present invention) via this reinforcing bracket allows most of the load applied from the tie down hook to be transmitted to the lock reinforcement, which makes it possible to prevent distortional deformation.

From the viewpoint of ensuring durability, it is important to achieve a configuration that can transmit and disperse input loads to various parts as in the above-described technique disclosed in Japanese Patent Laid-open Publication No. Sho58-73450. However, the technique of Japanese Patent Laid-open Publication No. Sho58-73450 has taken measures only against the load applied from the tie down hook, and cannot ensure durability against other input loads that are repeatedly applied during the life cycle of a vehicle, or in other words, cannot prevent distortional deformation. Moreover, in order to prevent distortional deformation, there is a need for a configuration that transmits input loads in an efficient manner, instead of just transmitting and dispersing input loads to various parts.

In view of the foregoing problems, it is an object of the present invention to provide a vehicle rear structure that can efficiently transmit input loads and ensure sufficient durability against any input load that may be repeatedly applied in normal usage during the life cycle of a vehicle.

### SUMMARY

A vehicle rear structure is provided that can efficiently transmit input loads, and ensure sufficient durability against any input load that may be repeatedly applied in normal usage during the life cycle of a vehicle. A representative configuration of a vehicle rear structure according to the present invention is a vehicle rear structure for supporting, at the rear of a vehicle, an opening and closing body that can be opened and closed, including: a back panel disposed in an area extending from a lower end of the opening and closing body to the bottom of the vehicle; and a striker bracket provided substantially at the center in the width direction of the vehicle on a vehicle front-side of the back panel and extending from the vicinity of an upper end of the back panel to the vicinity of a lower end thereof, wherein, in a cross section as viewed from the side of the vehicle, the respective upper ends and lower ends of the back panel and the striker bracket are coupled together, and a gap is formed between the back panel and the striker bracket.

A representative configuration of a vehicle rear structure according to the present invention for solving the above-described problems is a vehicle rear structure for supporting, at the rear of a vehicle, an opening and closing body that can be opened and closed, including: a back panel disposed in an area extending from a lower end of the opening and closing body to the bottom of the vehicle; and a striker bracket provided substantially at the center in the width direction of the vehicle on a vehicle front-side of the back panel and extending from the vicinity of an upper end of the back panel to the vicinity of a lower end thereof, wherein, in a cross section as viewed from the side of the vehicle, the respective upper ends and lower ends of the back panel and the striker bracket are coupled together, and a gap is formed between the back panel and the striker bracket.

With this configuration, the respective upper ends and lower ends of the back panel and the striker bracket are coupled together, with a gap extending continuously between the back panel and the striker bracket. Thereby, these components will not interfere with each other when an input load is applied thereto, and can each efficiently transmit the input load in the vertical direction. Accordingly, it is possible to ensure sufficient durability against any input load that may be repeatedly applied in normal usage, thus preventing distortional deformation.

Preferably, the back panel includes a first projecting portion located at substantially the center thereof in the width direction of the vehicle and projecting toward the rear of the vehicle, and the first projecting portion is spaced apart from the striker bracket, thus forming the gap. With this configuration, it is possible to form the above-described gap in a suitable manner.

Preferably, the striker bracket includes a second projecting portion projecting toward the front of the vehicle, and the second projecting portion is spaced apart from the back panel, thus forming the gap. With this configuration, it is possible to form the above-described gap in a suitable manner.

It is preferable that the vehicle rear structure further includes: a tail-end member provided on the vehicle front side relative to the back panel and the striker bracket, overlapping with an upper portion of the back panel, and extending in the width direction of the vehicle; a retainer that holds a striker for latching the opening and closing body, wherein the retainer is overlapped with the tail-end member and the striker bracket on the vehicle rear side of the tail-end member and the striker bracket, and these three components are coupled together.

With this configuration, it is possible to ensure the mounting strength for the retainer. Furthermore, since the retainer is coupled to the tail-end member, for example, an input load applied when closing the back door is dispersed in the width direction of the vehicle via the tail-end member. Accordingly, it is possible to reduce input loads in the vertical (up-down) direction by dispersing input loads in the width direction of the vehicle and the vertical direction, and also to more efficiently transmit input loads in the vertical direction with the above-described configuration.

Preferably, a lower end of the striker bracket extends in the front-rear direction of the vehicle, and is coupled to a longitudinal member fixed to a rear part of the undersurface of a body floor panel of the vehicle. With this configuration, transmission of input loads is carried out between the lower end of the striker bracket and the longitudinal member, and therefore, it is possible to facilitate transmission and dispersion of input loads to various parts, and ensure sufficient durability against any input load that may be repeatedly applied in normal usage, thus preventing distortional deformation.

Another representative configuration of a vehicle rear structure according to the present invention for solving the above-described problems is a vehicle rear structure for supporting, at the rear of a vehicle, an opening and closing body that can be opened and closed, including: a back panel disposed in an area extending from a lower end of the opening and closing body to the bottom of the vehicle; a striker bracket provided substantially at the center in the width direction of the vehicle on a vehicle rear-side of the back panel and extending from the vicinity of an upper end of the back panel to the vicinity of a lower end thereof; and a tail-end member provided on the vehicle rear side relative to the back panel and the striker bracket, overlapping with an upper portion of the back panel, and extending in the width direction of the vehicle, wherein the back panel includes a first projecting portion located substantially at the center thereof in the width direction of the vehicle and projecting toward the front of the vehicle, the striker bracket includes a second projecting portion projecting toward the rear of the vehicle, and the back panel, the striker bracket, the tail-end member are coupled to each other at flange faces provided in the respective upper portions thereof, and a gap extends continuously between the first projecting portion and the second projecting portion.

With this configuration as well, it is possible to achieve the same functions and effects as described above.

According to the present invention, it is possible to provide a vehicle rear structure that can efficiently transmit input loads, and ensure sufficient durability against any input load that may be repeatedly applied in normal usage during the life cycle of a vehicle.

### BRIEF DESCRIPTION OF THE DRAWINGS

Embodiments of the invention will be described, by way of example only, with reference to the drawings.

FIG. 1 is a front view of a vehicle rear structure according to a first embodiment of the present invention, as viewed from the front of a vehicle.

FIG. 2 is a perspective view of the vehicle rear structure shown in FIG. 1, as viewed from above.

FIG. 3 is a perspective view of the vehicle rear structure shown in FIG. 1, as viewed from below.

FIG. 4 is an exploded perspective view of the vehicle rear structure shown in FIG. 2.

FIGS. 5A and 5B are enlarged views of an area near the striker shown in FIG. 2.

FIG. 6 is a cross-sectional view taken along the arrows A-A in FIG. 1.

FIG. 7 is a cross-sectional view taken along the arrows B-B in FIG. 1.

FIG. 8 is a cross-sectional view of a vehicle rear structure according to a second embodiment of the present invention, as viewed from the side.

### DETAILED DESCRIPTION OF THE INVENTION

Hereinafter, preferred embodiments of the present invention will be described in detail with reference to the accompanying drawings. The dimensions, materials, and other specific numerical values described in this embodiment are merely examples for facilitating the understanding of the present invention, and are not to be construed as limiting the invention unless otherwise stated. It should be noted that elements constituting substantially identical functions and configurations are denoted by identical reference numerals in the present specification and the drawings, and hence redundant description has been omitted. Also, illustration of elements that are not directly relevant to the present invention has been omitted.

### First Embodiment

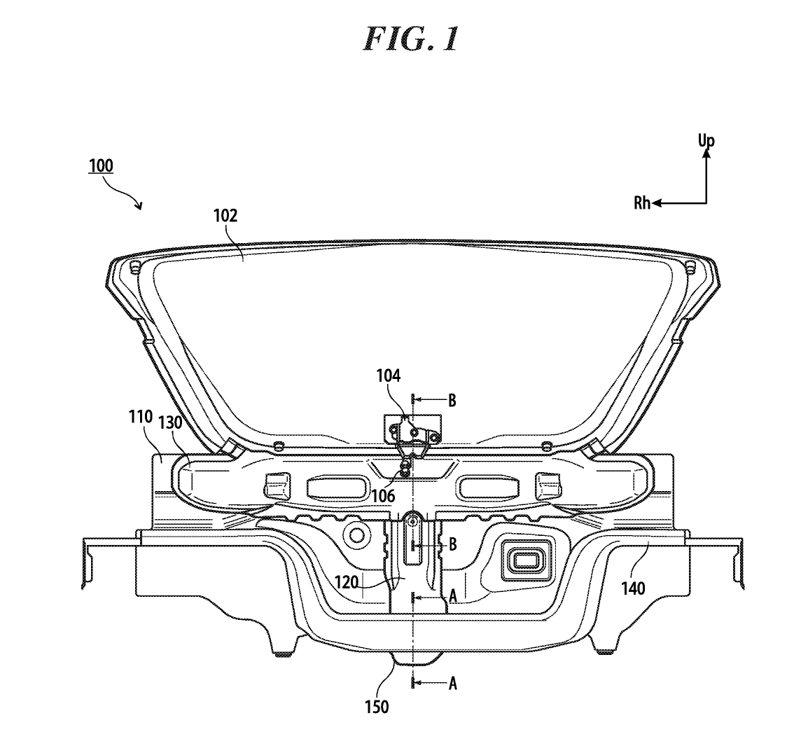

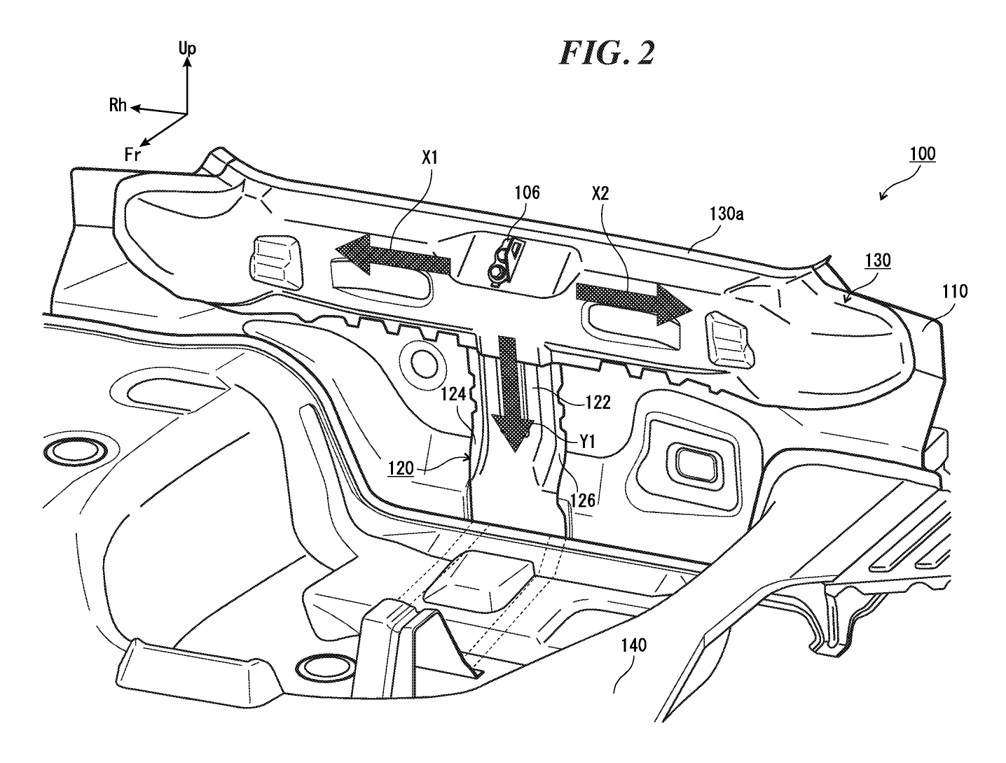

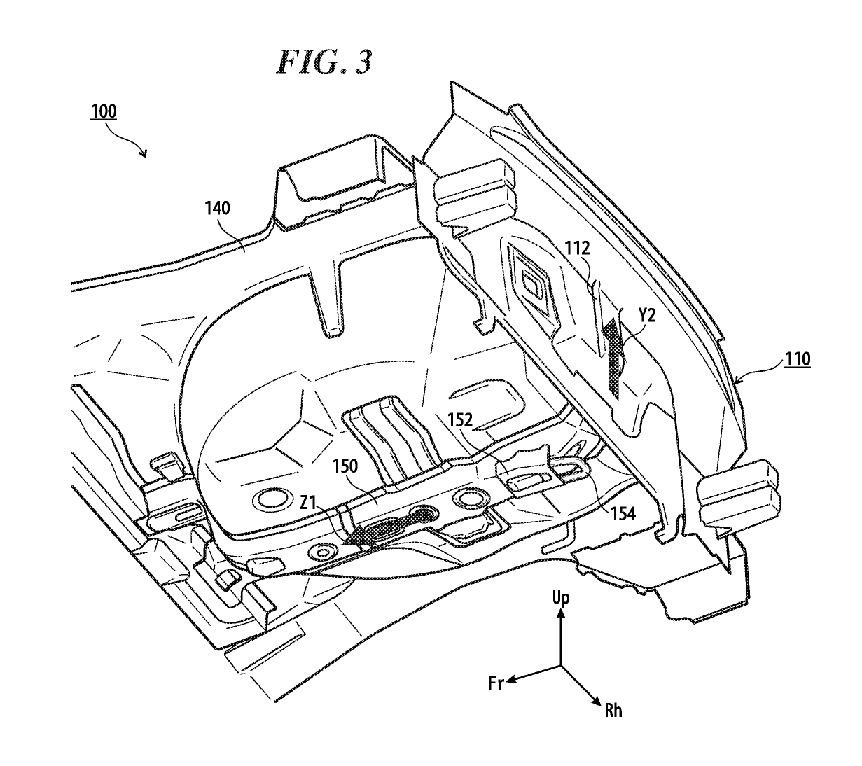

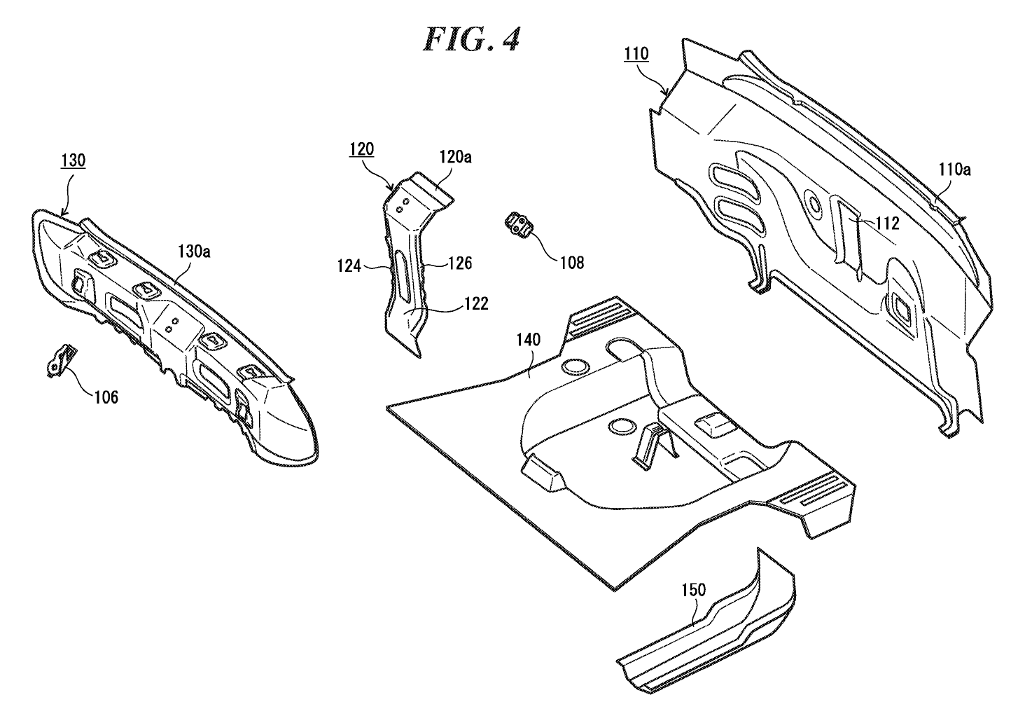

FIG. 1 is a front view of a vehicle rear structure 100 according to a first embodiment of the present invention, as viewed from the front of a vehicle. FIG. 2 is a perspective view of the vehicle rear structure 100 shown in FIG. 1, as viewed from above. FIG. 3 is a perspective view of the vehicle rear structure 100 shown in FIG. 1, as viewed from below. FIG. 4 is an exploded perspective view of the vehicle rear structure 100 shown in FIG. 2. For convenience, the illustration of a back door 102 is omitted in FIGS. 2 and 3. In the drawings, the arrow Fr denotes the front of the vehicle, the arrow Rh denotes the right side of the vehicle, and the arrow Up denotes the upper side.

As shown in FIG. 1, a back door 102 serving as an opening and closing body is provided at the rear of an automobile. A latch 104 is connected to the back door 102, and the closed state of the back door 102 can be maintained by the latch 104 meshing with a striker 106 that is connected to the vehicle body.

As shown in FIG. 4, the vehicle rear structure 100 is provided with a back panel 110, extending from the lower end of the back door 102 to the bottom of the vehicle. A striker bracket 120 is provided at substantially the center in the width direction of the vehicle on the vehicle front-side of the back panel 110. The striker bracket 120 extends from the vicinity of the upper end of the back panel 110 to the vicinity of the lower end thereof. A tail-end member 130 is provided on the vehicle front-side of the back panel 110 and the striker bracket 120. The tail-end member 130 overlaps with the upper portion of the back panel 110, and extends in the width direction of the vehicle.

The lower ends of the back panel 110 and the striker bracket 120 are connected to a vehicle body floor panel 140. A towing hook member 150 serving as a longitudinal member extending in the vehicle front-rear direction is fixed to the rear part of the undersurface of the vehicle body floor panel 140. Here, a hatchback vehicle is shown as an example, but the present invention is also applicable to a sedan vehicle. In the case of a sedan vehicle, a trunk lid, instead of the back door 102, serves as the opening and closing body, and the longitudinal member extending in the vehicle front-rear direction is fixed to the undersurface of a trunk floor panel, which constitutes the bottom of the vehicle.

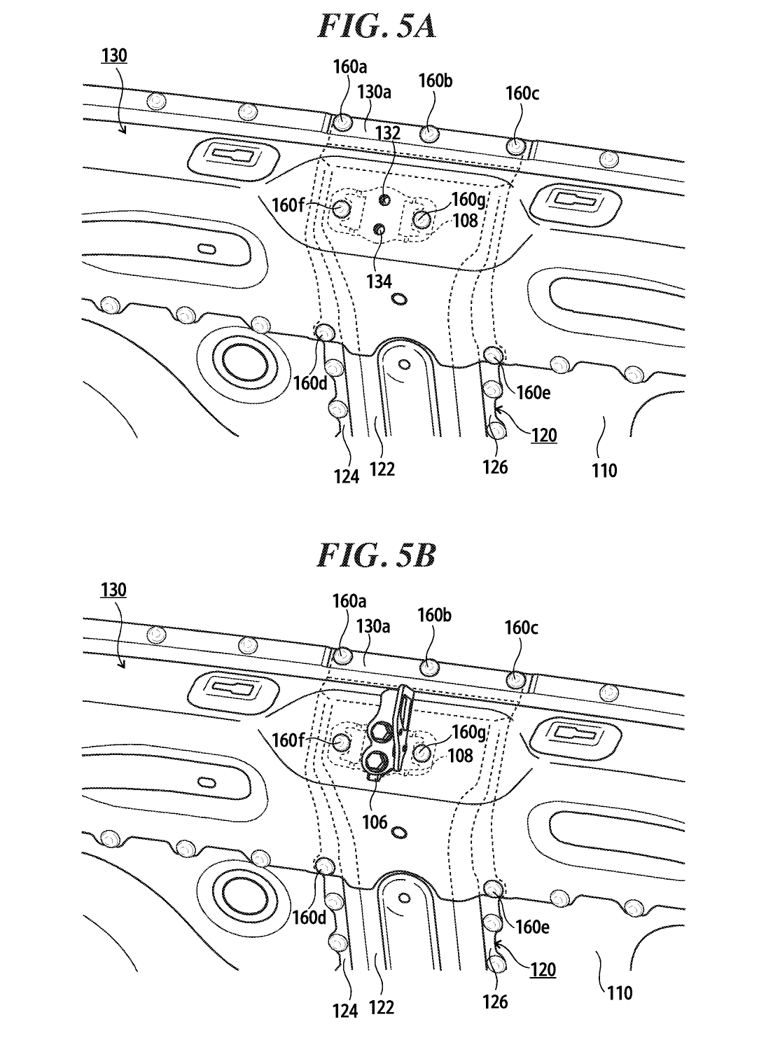

FIGS. 5A and 5B are enlarged views of an area near the striker 106 shown in FIG. 2. FIG. 5A shows the area before the striker 106 is mounted, and FIG. 5B shows the area after the striker 106 has been mounted. Note that FIGS. 5A and 5B show multiple welding spots, only representative ones of which are denoted by reference numerals.

As shown in FIG. 5A, with the vehicle rear structure 100, a retainer 108 holding the striker 106 is overlapped with the striker bracket 120 and the tail-end member 130 on the vehicle rear side of these components, and the three components are coupled together. The coupling locations are shown as welding spots 160f and 160g in FIGS. 5A and 5B.

As shown in FIG. 5B, the striker 106 is fastened via mounting apertures 132 and 134 to the retainer 108, which has been coupled by coupling of three components as described above. Accordingly, the mounting strength for the striker 106 can be ensured. In order to avoid stress concentration and prevent distortional deformation, it is preferable not to form any unnecessary aperture in the tail-end member 130 other than the mounting apertures 132 and 134.

As shown in FIGS. 5A and 5B, in the portion where the striker bracket 120 and the tail-end member 130 cross each other, the three components, i.e., the back panel 110, the striker bracket 120, and the tail-end member 130 are coupled together. The coupling locations are shown as welding spots 160a, 160b, 160c, 160d, and 160e in FIGS. 5A and 5B.

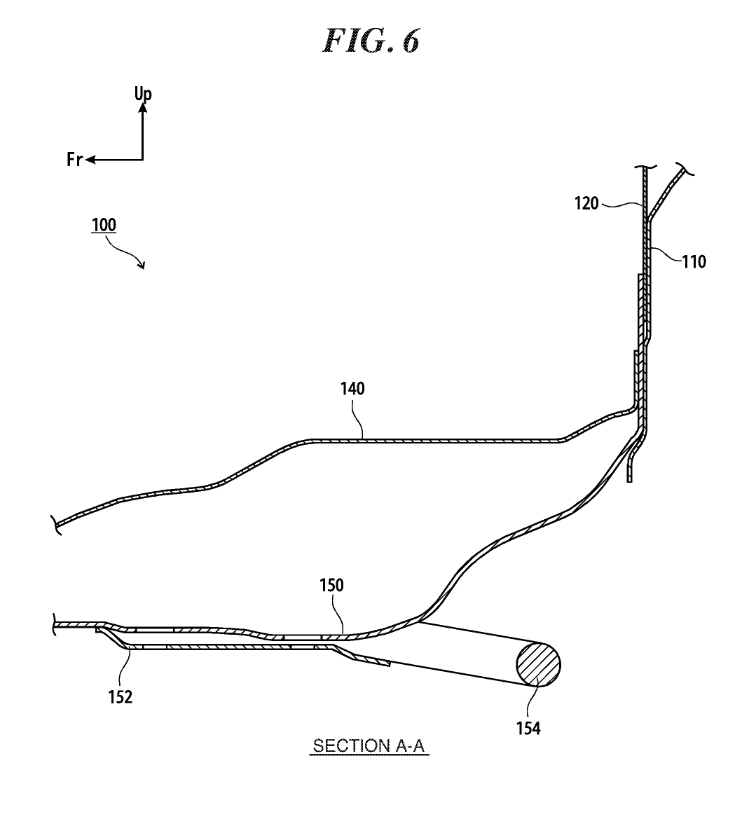

FIG. 6 is a cross-sectional view taken along the arrows A-A in FIG. 1. As shown in FIG. 6, with the vehicle rear structure 100, the lower ends of the back panel 110 and the striker bracket 120 are coupled to the vehicle body floor panel 140 and the towing hook member 150. This allows any input load transmitted through a first projecting portion 112 and a second projecting portion 122 to be transmitted and dispersed in the vehicle front-rear direction, and also allows any input load from the vehicle body floor panel 140 and the towing hook member 150 to be transmitted and dispersed in the vertical direction.

Additionally, a towing hook reinforcement 152 is coupled to the towing hook member 150. The towing hook 154 is held by the towing hook member 150 and the towing hook reinforcement 152.

We now refer to FIG. 2. With the above-described configuration, any input load applied when closing the back door 102 is dispersed via the tail-end member 130 in the width direction X1 and X2 of the vehicle, and dispersed via the back panel 110 and the striker bracket 120 in the downward direction Y1. Further, the input load in the downward direction Y1 is also transmitted and dispersed in the vehicle front-rear direction because the lower ends of the back panel 110 and the striker bracket 120 are coupled to the vehicle body floor panel 140 and the towing hook member 150.

We now refer to FIG. 3. With the above-described configuration, any load applied to the vehicle when a jack-up is performed using the vicinity of the towing hook 154 as the jack point is dispersed via the towing hook member 150 in the vehicle front-rear direction (in particular, the vehicle front direction Z1), and dispersed via the back panel 110 and the striker bracket 120 in the upward direction Y2.

As shown in FIG. 3, the back panel 110 is provided with a first projecting portion 112 located at substantially its center in the width direction of the vehicle and projecting toward the rear of the vehicle. As shown in FIG. 4 and FIGS. 5A and 5B, the striker bracket 120 is provided with a second projecting portion 122 projecting toward the front of the vehicle. The second projecting portion 122 is provided, on its lateral opposite sides, with vertical flanges 124 and 126 for being welded to the back panel 110, and is substantially hat-shaped (has a steel sheet-pile shape) in a cross section as viewed from above or below. The first projecting portion 112 is also substantially hat-shaped in a cross section as viewed from above or below. This shape is excellent also in term of ensuring rigidity, and can provide the required rigidity.

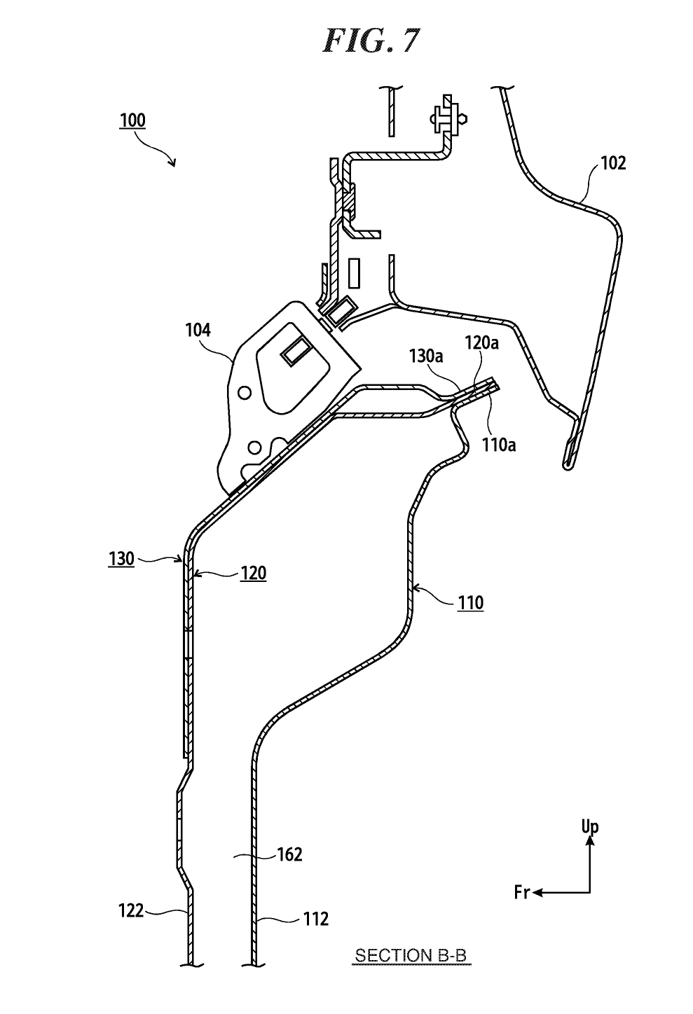

FIG. 7 is a cross-sectional view taken along the arrows B-B in FIG. 1. As shown in FIG. 7, with the vehicle rear structure 100, the first projecting portion 112 and the second projecting portion 122 are opposed to each other, and they project in opposite directions, and thereby, a gap 162 is formed therebetween. The back panel 110, the striker bracket 120, and the tail-end member 130 are coupled to each other at flange faces 110a, 120a, and 130a provided in their respective upper portions (upper ends), and the gap 162 extends continuously from the flange faces 110a, 120a, and 130a to the lower ends coupled to the vehicle body floor panel 140. Note that the gap 162 is located under the retainer 108 and the striker 106.

The input load in the downward direction Y1 and the input load in the upward direction Y2, which can be dispersed and reduced by the previously described configuration in which the retainer 108 is coupled by coupling of three components, can be further smoothly and efficiently transmitted by providing the above-described continuous gap 162. The reason for this is that the back panel 110 and the striker bracket 120 can uniformly transmit input loads in the vertical direction without interfering with each other, with an open space maintained therebetween. This leads to a reduction in damage to the vehicle body, thus increasing the durability of the vehicle body. Note that when the back panel 110 and the striker bracket 120 are overlapped with each other and spot-welded to each other without providing any equivalent of the gap 162 of this embodiment, stress is concentrated on the spot-welded portion and input loads cannot be made uniform, and therefore, distortional deformation may occur in that portion.

As described thus far, with the above-described vehicle rear structure 100, input loads can be efficiently transmitted to various parts, and therefore, it is possible to ensure sufficient durability against any input load that may be repeatedly applied in normal usage during the life cycle of a vehicle, thus preventing distortional deformation.

Conventionally, a configuration has been mainly used in which a large aperture is formed in the tail-end member and the striker is mounted to the striker bracket via the aperture. Therefore, there has been a problem not only in that input loads cannot be transmitted and dispersed via the tail-end member in the width direction of the vehicle, but also in that the formation of the large aperture leads to stress concentration on the aperture and distortional deformation. In contrast, with the vehicle rear structure 100 described above, it is not necessary to form such a large aperture, and therefore it can also solve the problem of stress concentration. Since the vehicle rear structure 100 uses existing components without using any novel component, it will not necessitate any increase in costs and weight compared to the conventional structures. On the contrary, the vehicle rear structure 100 provides effects such as an increase in cargo space and a reduction in mold costs compared to the conventional structures.

### Second Embodiment

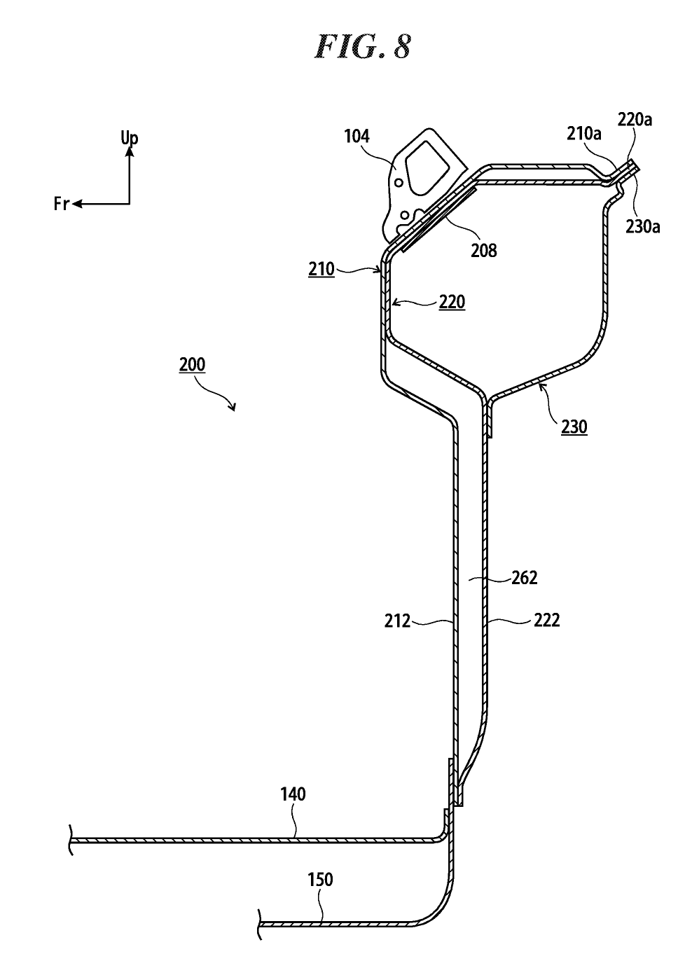

FIG. 8 is a cross-sectional view of a vehicle rear structure 200 according to a second embodiment of the present invention, as viewed from the side. As shown in FIG. 8, the second embodiment is different from the first embodiment in that the vehicle rear structure 200 includes a back panel 210 on the vehicle front side, and a tail-end member 230 on the vehicle rear side.

Specifically, with the vehicle rear structure 200, a striker bracket 220 extending from the vicinity of the upper end of the back panel 210 to the vicinity of the lower end thereof is provided substantially at its center in the width direction of the vehicle on the vehicle rear-side of the back panel 210 disposed in an area extending from the lower end of the back door to the bottom of the vehicle. The tail-end member 230 overlapping with the upper portion of the back panel 210 and extending in the width direction of the vehicle is provided on the vehicle rear side of the back panel 210 and the striker bracket 220. The back panel 210 is provided with a first projecting portion 212 located at substantially the center in the width direction of the vehicle and projecting toward the front of the vehicle, and the striker bracket 220 is provided with a second projecting portion 222 projecting toward the rear of the vehicle. The back panel 210, the striker bracket 220, and the tail-end member 230 are coupled to each other at flange faces 210a, 220a, and 230a provided in their respective upper portions, and a gap 262 extends continuously between the first projecting portion 212 and the second projecting portion 222.

The lower ends of the back panel 210 and the striker bracket 220 are coupled to the vehicle body floor panel 140 and the towing hook member 150. A retainer 208 is overlapped with the back panel 210 and the striker bracket 220 on the vehicle rear end side of these components, and the three components are coupled together. With this configuration as well, it is possible to achieve the same functions and effects as those of the first embodiment described above.

While preferred embodiments of the present invention have been described above with reference to the accompanying drawings, it should be appreciated that the present invention is not limited to the embodiments shown above. It will be apparent for a person skilled in the art that various modifications and variations may be made within the scope of the invention as defined in the appended claims, and those modifications and variations should be understood to be included within the technical scope of the present invention.

The present invention is applicable to a vehicle rear structure serving as a rear structure of an automobile.

What is claimed is:

1. A vehicle rear structure for supporting, at the rear of a vehicle, an opening and closing body that can be opened and closed, comprising:
a back panel disposed in an area extending from a lower end of the opening and closing body to the bottom of the vehicle; and
a striker bracket provided substantially at a center in a width direction of the vehicle on a vehicle front-side of the back panel and extending from a vicinity of an upper end of the back panel to a vicinity of a lower end thereof;
wherein, in a cross section as viewed from the side of the vehicle, the respective upper ends and lower ends of the back panel and the striker bracket are coupled together, and a gap is formed between the back panel and the striker bracket.

2. The vehicle rear structure according to claim 1, wherein the back panel includes a first projecting portion located at substantially the center thereof in the width direction of the vehicle and projecting toward the rear of the vehicle, and the first projecting portion is spaced apart from the striker bracket, thus forming the gap.

3. The vehicle rear structure according to claim 1, wherein the striker bracket includes a second projecting portion projecting toward the front of the vehicle, and the second projecting portion is spaced apart from the back panel, thus forming the gap.

4. The vehicle rear structure according to claim 1, further comprising:
a tail-end member provided on the vehicle front side relative to the back panel and the striker bracket, overlapping with an upper portion of the back panel, and extending in the width direction of the vehicle; and
a retainer that holds a striker for latching the opening and closing body;
wherein the retainer is overlapped with the tail-end member and the striker bracket on the vehicle rear side of the tail-end member and the striker bracket, and these three components are coupled together.

5. The vehicle rear structure according to claim 1, wherein a lower end of the striker bracket extends in a front-rear direction of the vehicle, and is coupled to a longitudinal member fixed to a rear part of a undersurface of a body floor panel of the vehicle.

6. A vehicle rear structure for supporting, at the rear of a vehicle, an opening and closing body that can be opened and closed, comprising:
a back panel disposed in an area extending from a lower end of the opening and closing body to the bottom of the vehicle;
a striker bracket provided substantially at a center in a width direction of the vehicle on a vehicle rear-side of the back panel and extending from a vicinity of an upper end of the back panel to a vicinity of a lower end thereof; and
a tail-end member provided on the vehicle rear side relative to the back panel and the striker bracket, overlapping with an upper portion of the back panel, and extending in the width direction of the vehicle;
wherein the back panel includes a first projecting portion located substantially at the center thereof in the width direction of the vehicle and projecting toward the front of the vehicle;
wherein the striker bracket includes a second projecting portion projecting toward the rear of the vehicle; and
wherein the back panel, the striker bracket, the tail-end member are coupled to each other at flange faces provided in the respective upper portions thereof, and a gap extends continuously between the first projecting portion and the second projecting portion.
